(19) United States
(12) Patent Application Publication
(10) Pub. No.: US 2015/0187339 A1
(43) Pub. Date: Jul. 2, 2015

(54) Previewing Notification Content

(71) Applicant: Motorola Mobility LLC, Libertyville, IL (US)

(72) Inventor: Alex Vaz Waddington, San Jose, CA (US)

(73) Assignee: Motorola Mobility LLC, Libertyville, IL (US)

(21) Appl. No.: 14/183,008

(22) Filed: Feb. 18, 2014

Related U.S. Application Data
(60) Provisional application No. 61/921,497, filed on Dec. 29, 2013.

(51) Int. Cl. G09G 5/393

(52) U.S. Cl. CPC G09G 5/393; G09G 2330/021

(57) ABSTRACT

In embodiments of previewing notification content, a computing device includes a display, a full-power processor, and a low-power processor that can present previews of notification content without utilizing the full-power processor. While the computing device is in a low-power state, the low-power processor can mask content retrieved from a buffer to expose a preview of the notification content. The preview of the notification content can then be presented via the display without waking the full-power processor from a sleep state.

### RELATED APPLICATION

This application claims the benefit of U.S. Provisional Application Ser. No. 61/921,497 filed Dec. 29, 2013, the entire contents of which are hereby incorporated herein by reference in their entirety.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

Many computing devices, such as mobile phones, tablet computers, laptop computers, and portable media devices, receive notifications that include text or other content. The content of these notifications is typically processed or rendered using a high-speed processing component of a computing device, such as an application processor. For example, reception of a notification may launch an associated application, which renders content of the notification using the application processor. The application then presents the rendered content of the notification through a display of the computing device to enable interaction with said content.

Relative to other components of a computing device, however, the application processor and display consume considerable power. As such, the processing and rendering of notifications increases power consumed by a computing device. This increased power consumption results in shortened device run-times or restricted use of device resources when extended run-times are desired.

### BRIEF DESCRIPTION OF THE DRAWINGS

Embodiments of previewing notification content are described with reference to the following Figures. The same numbers may be used throughout to reference like features and components that are shown in the Figures.

FIG. 1 illustrates an example system in which embodiments of previewing notification content can be implemented.

FIG. 2 illustrates various components of an example system that can implement embodiments of previewing notification content.

FIG. 3 illustrates various content mask configurations that are useful to implement embodiments of previewing notification content.

FIG. 4 illustrates an example method of masking a composite image in accordance with one or more embodiments.

FIG. 5 illustrates an example method of applying a mask to content in accordance with one or more embodiments.

FIG. 6 illustrates an example of presenting exposed notification content in accordance with one or more embodiments.

FIG. 7 illustrates an example method of previewing notification content in accordance with one or more embodiments.

FIG. 8 illustrates various components of an example electronic device that can implement embodiments of previewing notification content.

### DETAILED DESCRIPTION

In embodiments of previewing notification content, a computing device includes a display, a full-power processor (e.g., application processor), and a low-power processor. Content of a notification is typically rendered by the full-power processor at high-resolution for presentation via the display. As described above, full-power processors rendering high-resolution content and displays presenting said content consume considerable power relative to other components of a computing device. Accordingly, use of the full-power processor and display conflicts with many power conservation measures implemented by computing devices, such as low-power states in which an application processor and display reside in respective sleep states.

As such, reception of notifications while a computing device is in a low-power state can increase power consumption of the device because the application processor and display wake to render and present content of the notifications. This increased power consumption impacts computing device run-times or resource availability when extended run-times are desired. Embodiments of previewing notification content enable a lower-power processor (e.g., micro-controller) to mask pre-rendered content to provide a preview of the notification content while a full-power processor remains in a sleep state. Permitting the full-power processor to remain in a sleep-state reduces power consumption of the computing device, enabling longer device run-times or expanded use of the display for presenting the previews of content.

In some embodiments, notifications are received while a computing device is in a low-power state, in which an application processor and display are in sleep states. The application processor may periodically wake to determine if any notifications have been received since a previous wake event. The received notifications are stored and content associated with each of the notifications is rendered, such as to provide a low-resolution grayscale image. The application processor then stores each grayscale image and any associated text into a corresponding one of a set of color-channel buffers. After storing the rendered content of the notifications, the application processor returns to the sleep state to conserve power.

Once the rendered content is stored in the set of color-channel buffers, a low-power processor of the computing device can present previews of the notification content without waking the full-power processor. To do so, the low-power processor retrieves the rendered content from the set of channel buffers. A content mask is then applied to the retrieved content to expose one of the low-resolution images and associated text. The low-power processor then presents the exposed low-resolution image and text via the display for a user to preview. By so doing, previews of the notification content can be presented by the display, without waking the application processor.

While features and concepts of the described techniques for previewing notification content can be implemented in any number of different devices, systems, and/or configurations, embodiments of previewing notification content are described in the context of the following example devices, systems, and methods.

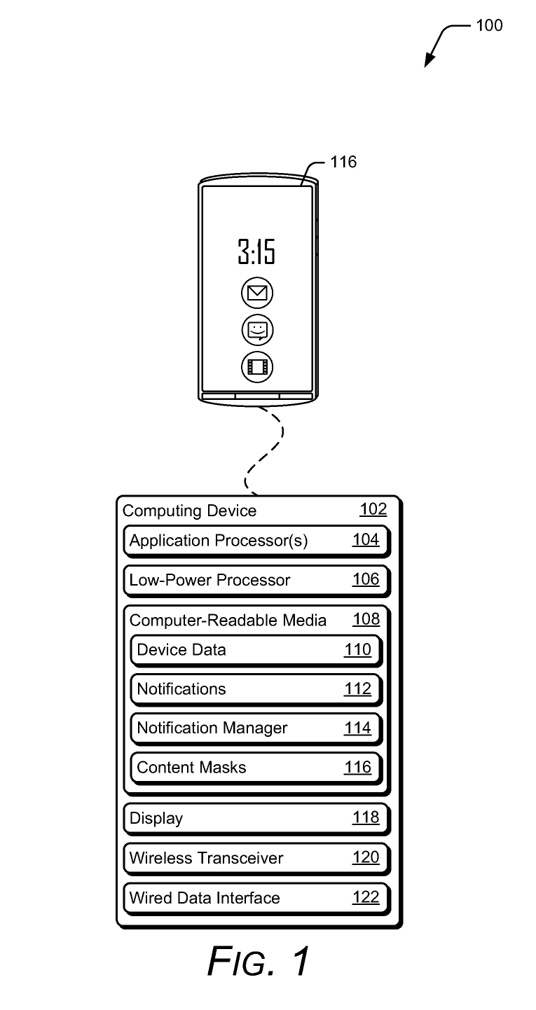

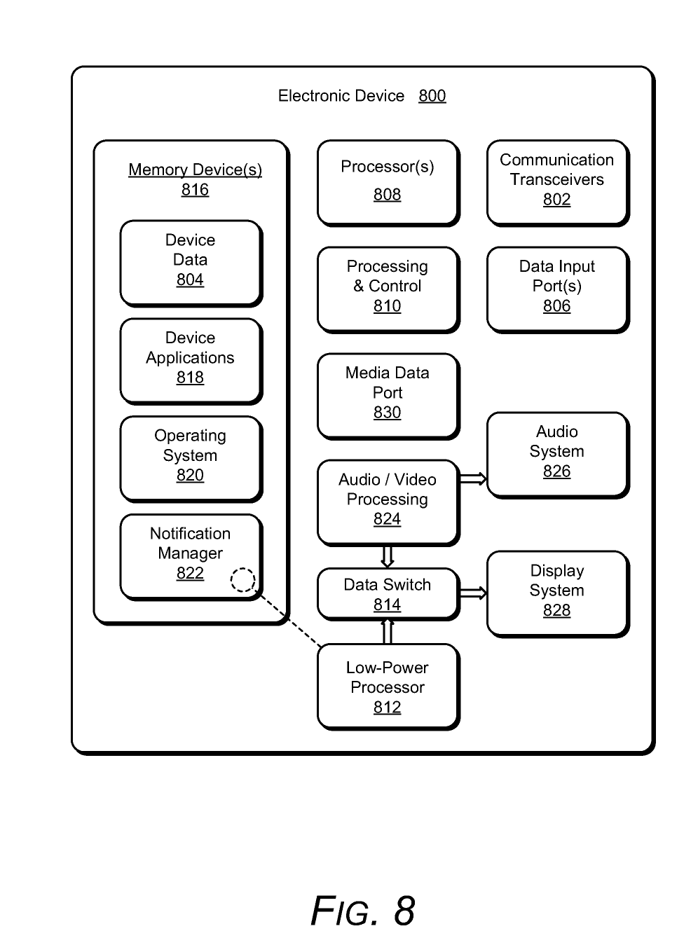

FIG. 1 illustrates an example system 100 in which embodiments of previewing notification content can be implemented. The example system 100 includes a computing device 102 that may be any type of portable electronic device, such as a smart-phone, mobile phone, tablet computer, handheld navigation device, portable gaming device, and/or portable media playback device. The computing device 102 may also be any type of device as further described with reference to the example electronic device shown in FIG. 8. The computing device 102 has multiple operational states, which range from a fully-on state to a fully-off state. The operational states may include a low-power state (e.g., sleep state) in which various components of the device enter respective low-power states to conserve power.

The computing device 102 includes an application processor 104 and a low-power processor 106. The application processor 104 may be configured as a single or multi-cored full-power processor that includes graphic rendering capabilities. These graphic rendering capabilities allow the application processor 104 to render high-resolution images, low-resolution images, moving graphics, and may be provided by a dedicated graphics processing unit (GPU) associated with the application processor 104. The application processor 104 may also include multiple operation states, including a low-power state or sleep state in which functionalities of the application processor 104 are unavailable. In some embodiments, causing the application processor 104 to enter the sleep state is effective to conserve power of the computing device 102.

The low-power processor 106 may be configured as a low-power processor or micro-controller that is unable to fully render graphics or display high-resolution images. In some cases, the low-power processor lacks an integrated display controller and/or a display-specific data interface. In other cases, the low-power processor 106 may be a processor in a low-power state in which the processor is unable to render graphical content. For example, a low-power processor may be implemented by causing a higher-power processor, or processor core, to enter a low-power state in which capabilities of the higher-power processor are reduced. When the computing device 102 is in a sleep state, the low-power processor 106 can manage various input/output functionalities or background tasks. The low-power processor 106 may be implemented as a reduced-instruction set computing (RISC) processor which has a smaller instruction set, operates at a lower frequency, or has fewer processing capabilities than the application processor 104.

For example, when the application processor 104 is configured as a multi-core full-power processor implementing a 32-bit instruction set, the low-power processor 106 may be configured as a RISC-based micro-controller that implements a 16-bit instruction set. The application processor 104 and/or low-power processor 106 may each be implemented separately as disparate components (shown), or implemented together as an application processor with integrated companion micro-controller (not shown).

The computing device 102 also includes computer readable-media 108 (CRM 108), which stores device data 110 and notifications 112 of the computing device 102. The CRM 108 may include any suitable memory or storage device implemented at least in part as a physical device, which does not include propagating signals or waveforms. Example memory types of devices include random-access memory (RAM), static RAM (SRAM), dynamic RAM (DRAM), non-volatile RAM (NVRAM), read-only memory (ROM), or Flash memory useful to store the device data 110, notifications 112, or metadata.

The device data 110 may include user data, multimedia content, applications and/or an operating system of the computing device 102, which are executable by the application processor 104 to provide various functionalities of the computing device 102. The notifications 112 may include messages or alerts received by the computing device 102 from external sources, such as servers, messaging applications, social networks, and the like. A notification 112 may include any one of an email, a short message service (SMS) message, a multimedia messaging service (MMS) message, a picture message, an internet link, a video message, a missed-call alert, a software update, a social-media message, an application-specific alert, and so on.

Each notification 112 may also include content, such as text, a picture, video content, sound content, metadata, origination information, or contact information. In some embodiments, a type of notification is associated with one or more applications of computing device 102. For example, MMS messages can be associated with a messaging application to process text and contact information, and a multimedia application to render images, sound, or video associated with the MMS messages.

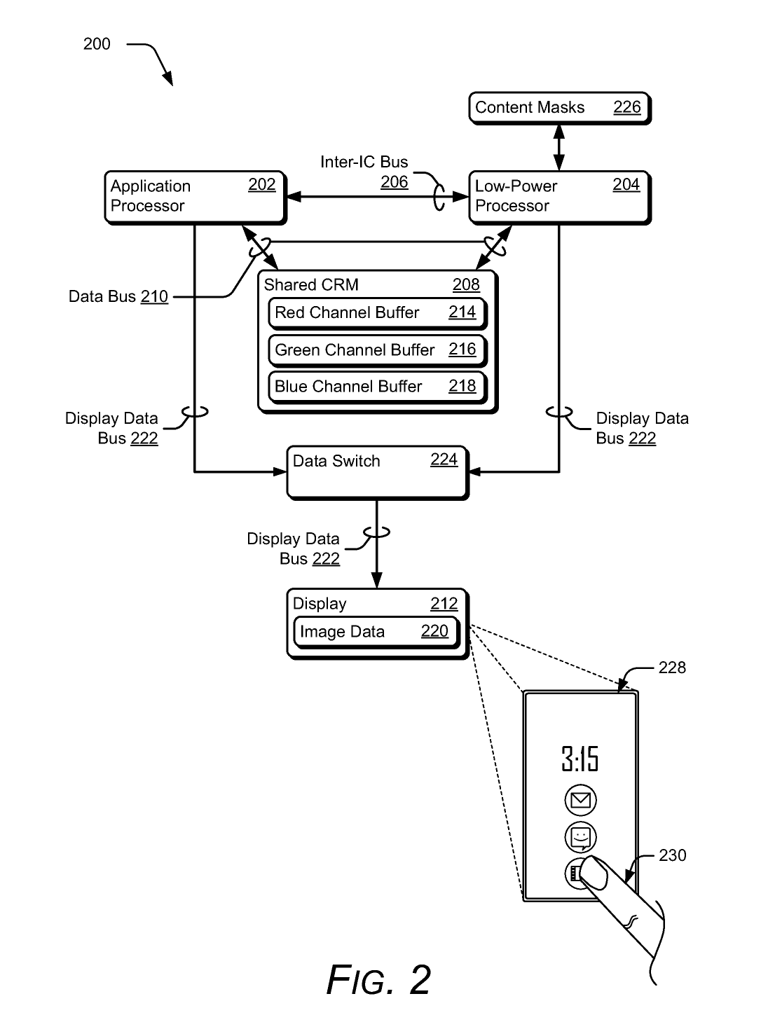

The computing device 102 also includes a notification manager 114, which, in one implementation, is embodied on the CRM 108 (as shown) as processor-executable instructions. Alternately or additionally, the notification manager 114 may be implemented in whole or part as hardware logic or circuitry integrated with or separate from other components of the computing device 102 (e.g. the application processor 104 or low-power processor 106). The computing device 102 also includes content masks 116, which are stored in CRM 108 and accessible to other components of computing device 102. Example implementations of the notification manager 114 and content masks 116 are described further with reference to FIGS. 2-8. In at least some embodiments, the notification manager 114 enables low-power processor 106 to generate and present previews of notification content.

The computing device 102 includes a display 118 for presenting visual content to users. The display 118 may be configured as any suitable type of display such as a liquid crystal display (LCD) or an active-matrix organic light-emitting diode (AMOLED) display. The visual content presented by the display 118 is based on display data received from other components of the computing device 102. This display data is typically received via a display-specific data interface of the display 118, such as a mobile industry processor interface (MIPI), mobile display digital interface (MDDI), DisplayPort, or embedded DisplayPort interface.

The computing device 102 is also capable of communicating data via a wireless transceiver 120 and/or a wired data interface 122. In some embodiments, notifications 112 are received from remote sources via wireless transceiver 120 or a wired data interface 122. The wireless transceiver 120 may be configured for communication via one or more types of data networks, such as a wireless personal-area-network (WPAN), wireless local-area-network (WLAN), wireless wide-area-network (WWAN), or a cellular network. Example standards by which these networks communicate include IEEE 802.15 (Bluetooth™) standards, IEEE 802.11 (WiFi™) standards, 3GPP-compliant cellular standards, or various IEEE 802.16 (WiMAX™) standards.

The wired data interface 122 may be configured to support any suitable type of wired communication, such as a universal serial bus (e.g., USB 2.0 or USB 3.0), audio, Ethernet, peripheral-component interconnect express (PCI-Express), serial advanced technology attachment (SATA), and the like. In some embodiments, the wired data interface 122 may be operably coupled with a custom or proprietary connector which integrates multiple data interfaces, along with a power connection for charging the computing device 102.

FIG. 2 illustrates various components of an example system that can implement embodiments of previewing notification content. As shown generally at 200, the components include an application processor 202 and a low-power processor 204, such as the application processor 104 and low-power processor 106 described with reference to FIG. 1. The application processor 202 and low-power processor 204 can communicate status or control information via an inter-integrated-circuit bus 206 (inter-IC bus 206). For example, the low-power processor can transmit signals to the application processor 202 via the inter-IC bus 206 effective to wake the application processor 202 from a sleep state. The inter-IC bus 206 may be configured as any suitable type of data bus, such as an inter-integrated circuit (I²C) compliant bus, IP-block cross bar, general purpose input/outputs (GPIOs), and the like.

The application processor 202 and low-power processor 204 can also access data stored in computer-readable media 208 (shared CRM 208) via a data bus 210. Although shown as having separate interfaces for each processor, the data bus 210 may be implemented as a shared bus or two separate busses (e.g., multi-port RAM) that communicate via a same or different data access protocols. Alternately or additionally, the shared CRM 208 may reside, in whole or part, within one of the application processor 202 or the low-power processor 204.

In some embodiments, the shared CRM 208 is implemented as buffer that is configured to store rendered content, such as imagery or text. In this particular example, the shared CRM 208 is implemented as an image buffer for a display 212, such as the display 118 described with reference to FIG. 1. In some cases, the display 212 includes an integrated image buffer (e.g., the shared CRM 208), which may be implemented via on-board video RAM (VRAM). The shared CRM 208 implemented as the image buffer may include a red color-channel buffer 214 (red channel buffer 214), a green color-channel buffer 216 (green channel buffer 216), and a blue color-channel buffer 218 (blue channel buffer 218). Alternately, the shared CRM 208 can be implemented as a multi-channel buffer in which data for each color-channel is stored in a separate area or memory space of the buffer.

The application processor 202 can render color imagery (e.g., pictures or text) into separate red-green-blue (RGB) component data, which is stored in a corresponding color-channel buffer of the shared CRM 208. Thus, a color image rendered by the application processor 202 is stored as a set of three RGB sub-images in the shared CRM 208. These RGB sub-images can then be combined or blended into a composite image, which is suitable for presentation via a display.

The application processor 202 can also render color imagery (e.g., high-resolution imagery) as grayscale imagery or lower-resolution imagery. Because less data is needed to encode grayscale or lower-resolution imagery, a grayscale image can be stored in a single color-channel buffer. By way of example, the application processor 202 can render three different high-resolution (e.g., color) images as three grayscale images, each of which can be stored in one of the color-channel buffers of the shared CRM 208. Alternately or additionally, grayscale or lower-resolution images can be combined into a single composite image that is suitable for storage in an image buffer. By so doing, multiple grayscale or lower-resolution images can be stored using less memory, which can be advantageous when a display includes a small or limited amount of on-board VRAM.

Once the imagery is rendered, the application processor 202 can transmit the rendered image data 220 (image data 220) to the display 212 via a display data bus 222. The display data bus 222 may be compliant with any suitable specification or standard, such as MIPI, MDDI, DisplayPort, or embedded DisplayPort. In some embodiments, the components include a data switch 224 to enable the application processor 202 and the low-power processor 204 to communicate with the display 212 via the display data bus 222. Alternately or additionally, a protocol converter (not shown) may be implemented between the low-power processor 204 and the data switch 224 to convert data transmitted by the low-power processor 204.

The low-power processor 204 can also access content or image data stored in the shared CRM 208, such as one or more grayscale images. Although the low-power processor 204 may not be capable of processing or rendering the content, the low-power processor 204 can present pre-rendered images or apply a content mask 226 to the content retrieved from the shared CRM 208. For example, the low-power processor 204 can present pre-rendered notification indicators as shown at 228. User input selecting one of these notifications for further interaction can then be received via a touch-screen of the example system as shown at 230. In some embodiments, the content masks 226 enable the low-power processor 204 to expose or filter content stored in the shared CRM 208. The exposed or filtered content can then be presented by the display 212 without utilizing the application processor 202.

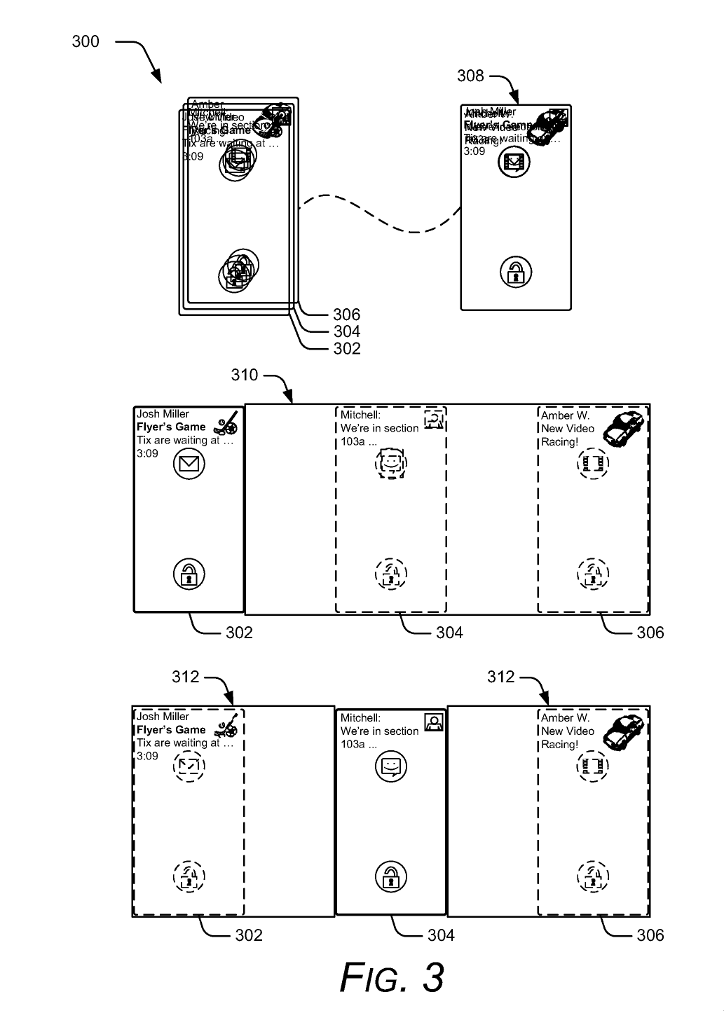

FIG. 3 illustrates example content 300 and example content filters that may be applied to the content in accordance with one or more embodiments. In this particular example, the content includes grayscale image 302, grayscale image 304, and grayscale image 306, each of which includes text and imagery associated with a different notification. Returning to FIG. 2, assume that the example system is in a sleep state and the application processor 202 is configured to periodically perform a wake event in which a low-power state is exited to query a server for notifications before the application processor 202 returns to the low-power state. Also assume that since a previous wake event, a user of the system has received an email, a text message, and a video message.

During the wake event, the application processor 202 downloads the notifications from the server and renders content of each notification as an image or associated text. In some cases, this rendering may be referred to as partial rendering because the content is not fully rendered at a native resolution (e.g., high-resolution color images or video). The image or text can be rendered in a solid color or in greyscale, which permits the image or text to be stored in a smaller buffer or less memory area. The application processor then stores each image or associated text in a color-channel buffer of the shared CRM 208. By so doing, the image or associated text can be stored as a solid color sub-image that approximates the notification content. Each of these solid color sub-images may include content useful to provide a grayscale preview of the content of each notification.

Before returning to the sleep state, the application processor 202 can also generate metadata that links the rendered content with each notification from which the content is rendered. In some embodiments, this metadata is useful to access a notification or invoke an application associated with the notification. When the application processor 202 returns to the sleep state, the low-power processor 204 can present a preview of the notification content by accessing the content stored in the shared CRM 208.

As shown generally at 300, the solid color sub-images can be converted to a set of separate grayscale images 302-306. Each of the grayscale images, which may also be referred to as a preview of notification content, are stored as a single color sub-image in a respective color-channel buffer. Accordingly, if the grayscale images 302-306 were blended or rendered as components of an RGB image, a composite image (e.g., flat image) of combined color data (e.g., red, blue, and green data) would be produced as shown at 308.

To filter or expose content associated with a particular notification, a content mask is applied to content stored in the color-channel buffers. The content stored in the color-channel buffers may be converted to grayscale content before, during, or after application of the content mask. In this example, the content masks 310, 312 applied may be similar to the content masks 116, 226 as described with reference to FIG. 1 or 2. For visual clarity, each grayscale image 302-306 is also shown in a respective color-channel, with the grayscale image 302 in the red channel, the grayscale image 304 in the green channel, and the grayscale image 306 in the blue channel. Here, assume that the content of the color-channel buffers is converted to the grayscale images 302-306 before application of the content masks.

To expose the content associated with a particular notification, the application processor 202 or the notification manager 114 applies a content mask that prevents display of content associated with other notifications. For example, to expose content associated with the email, which is stored as grayscale image 302 in the red-channel buffer, the content mask 310 is applied to mask or block the content stored in the green and blue channel buffers (indicated by dashed lines). The exposed grayscale image 302 and associated text of the email are then presented via a display for a user to view.

Alternately, to expose content associated with the text message, which is stored as grayscale image 304 in the green-channel buffer, the content mask 312 is applied to mask or block the content stored in the red and blue channel buffers (indicated by dashed lines). Although the content masks are illustrated as masking an entire color-channel of content, additional mask configurations may be implemented to block a portion of a color-channel enabling more or different combinations of content to be presented.

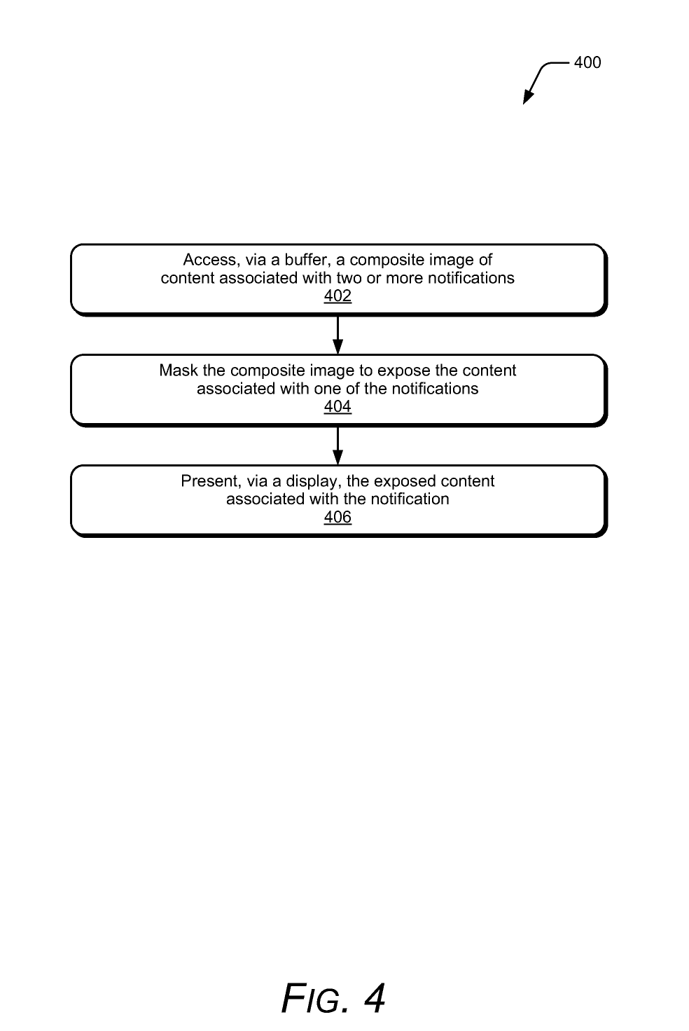

FIG. 4 illustrates an example method 400 of masking a composite image in accordance with one or more embodiments. The order in which the method is described is not intended to be construed as a limitation, and any number or combination of the described method operations can be performed in any order to perform a method, or an alternate method for previewing notification content. In at least some embodiments, one or more operations of method 400 may be performed while a device is in a low-power state.

At 402, a composite image of content is accessed via a buffer. The composite image may be accessed by a processor that is not in a state to render the content received from the buffer. Alternately or additionally, the processor may not be capable of fully-rendering the content received from the buffer, such as a low-power processor or microcontroller. In some cases, the composite image of content includes multiple grayscale images and text associated with respective notifications. In such cases, the multiple grayscale images can be rendered, and stored to the buffer, by another processor that is in a state capable of rendering the content associated with the notifications.

Each of the grayscale images and text can be stored in a particular portion of the buffer or in individual sub-buffers, such as color-channel buffers of an image buffer. In such cases, each grayscale image may be stored as a solid color sub-image that is convertible to a grayscale format. Alternately or additionally, a grayscale image or text may be a preview of notification content. In some cases, the preview of the content is a lower resolution image or frame captured from a high-resolution image or video. The preview of the text may indicate a subject of the notification, a sender of the notification, a time at which the notification is received, and the like.

At 404, the composite image is masked to expose content associated with one of the notifications. The composite image can be masked by applying a mask or filter that prevents content associated with the other notifications from being presented. The exposed content can include a grayscale image or text associated with the notification. In cases in which the composite image is stored in multiple color-channel buffers, all but one of the color-channels can be masked to expose rendered content stored in a particular color-channel buffer.

At 406, the exposed content associated with the notification is presented by a display. This exposed content, which is part of the composite image, can be presented by transmitting the masked composite image to a display or buffer thereof. In some cases, data of the exposed content is transmitted to the display by a low-power processor. Presenting the exposed content can be effective to enable present a preview of the notification content.

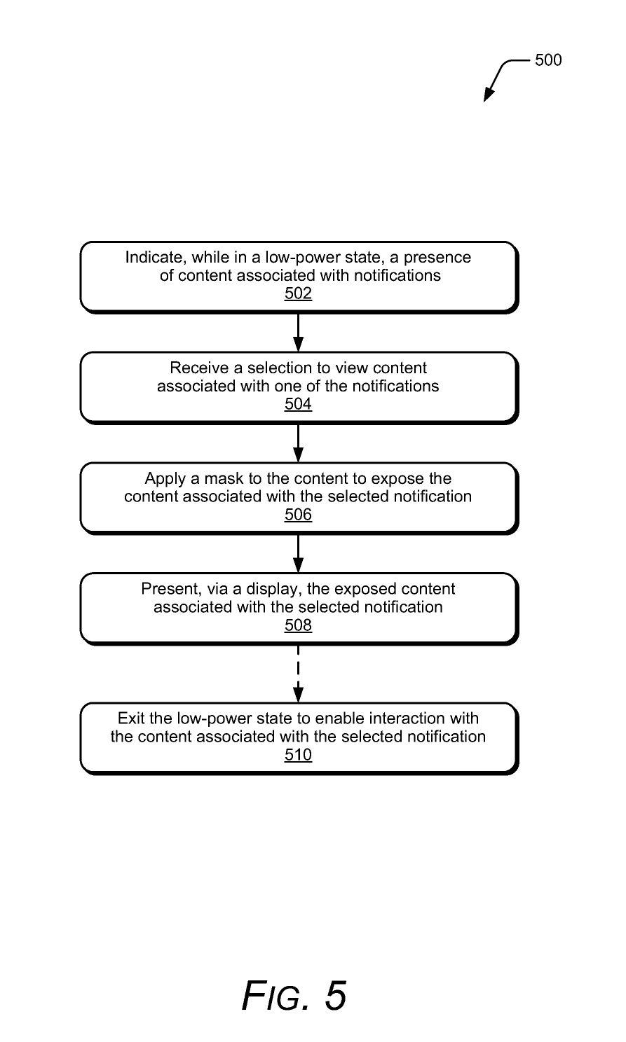

FIG. 5 illustrates an example method 500 of applying a mask to content in accordance with one or more embodiments. In at least some embodiments, one or more operations of method 500 may be performed while a computing device is in a sleep state.

At 502, a presence of content associated with notifications is indicated. The presence of content may be indicated via a display or a light-emitting diode of a device. In some cases, a symbol indicating a type of content is presented via the display of the device. This may include presenting a symbol indicating reception of an email, an SMS message, an MMS message, a social networking notification, and the like. By way of example consider FIG. 2, in which a presence of content is indicated generally at 228. Here, a notification manager 114 presents symbols indicating reception of an email, a text message, and a video message via display 212.

At 504, a selection to view content associated with one of the notifications is received. The selection can be received via any suitable input of the computing device, such as a touch screen, capacitive sensor, or hardware button. In some cases, the selection is received via an acoustic sensor as a voice command. In other cases, the selection may be received via notification symbols presented via the display. In the context of FIG. 2, the notification manager 114 receives a selection to view content associated with the video message via a touch-screen associated with the display 212 as shown at 230.

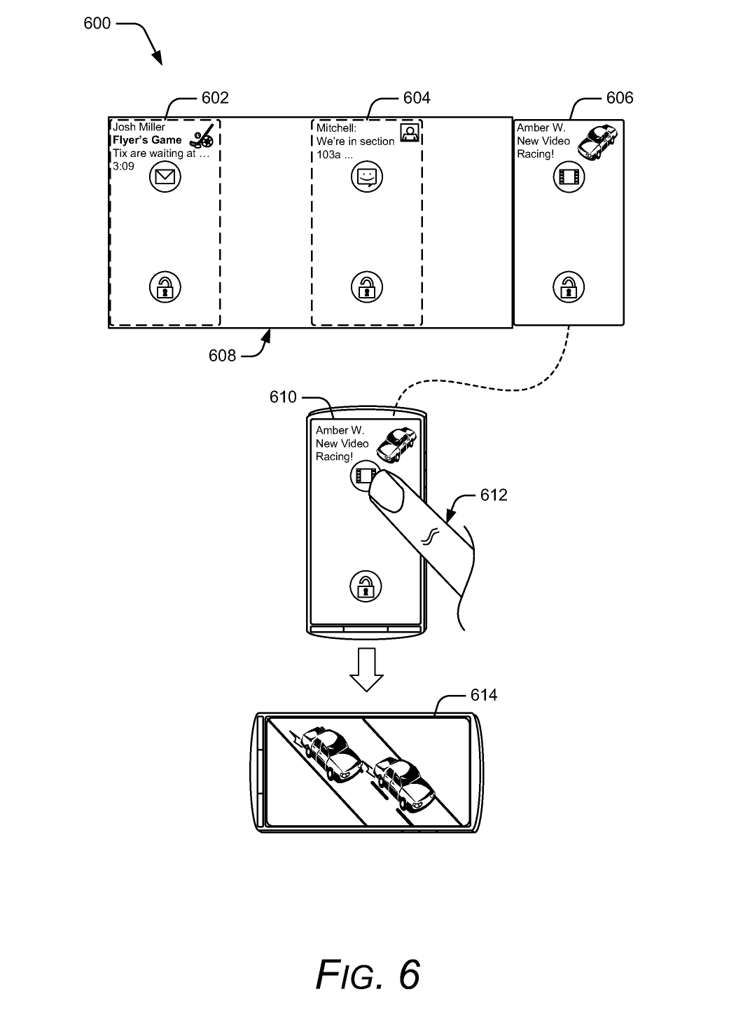

At 506, a mask is applied to the content to expose the content associated with the selected notification. The content for multiple applications is rendered as low resolution images or grayscale images, each of which is stored in a color-channel buffer of an image buffer. The mask can be configured to mask content in one or more of the color-channels effective to expose the content associated with the selected application. Continuing the ongoing example, consider FIG. 6 which shows grayscale images 602-606 that correspond with the email message, text message, and video message, respectively. Here, a content mask 608 is applied to the grayscale images to mask the grayscale images 602, 604 that are not selected for viewing. Accordingly, the grayscale image 606 that corresponds with the video message is exposed by the application of the content mask 608.

At 508, the exposed content associated with the selected notification is presented via a display. The exposed content can be presented as grayscale imagery, which can reduce an amount of power consumed by a display. For example, a minimal number of pixels of an OLED display can be illuminated to present the grayscale content. Presenting the exposed content can be effective to enable a presentation preview of the notification content. In the context of the present example, the grayscale image 606 that is associated with the video message is presented at 610.

Optionally at 510, a low-power state is exited to enable interaction with the content of the selected notification. In some cases, the low-power state of a processor is exited in response to receiving a user input. The user input can invoke an application associated with a notification. Once invoked, the application fully renders content of the notification, such as high-resolution imagery or video. Concluding the ongoing example, the user input is received via the preview of the video message at 612. In response to receiving the user input, a video application of the computing device is invoked. The video application then renders the video message using an application processor and presents the fully rendered content of the video message, which is shown at 614.

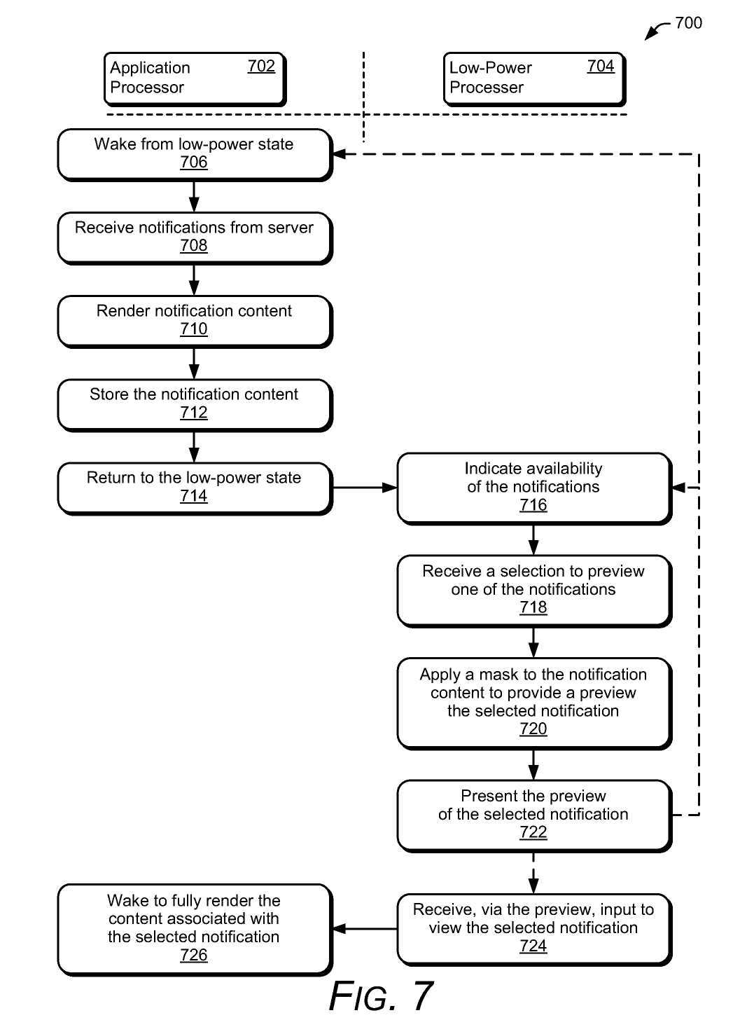

FIG. 7 illustrates an example method 700 of previewing notification content in accordance with one or more embodiments. Operations of method 700 are performed by an application processor 702 and a low-power processor 704, each of which may implement a notification manager to perform said operations. The application processor 702 and low-power processor 704 may be similar to the application processor 104 and low-power processor 106 as described with reference to FIG. 1.

At 706, an application processor 702 of a device wakes from a low-power state. The application processor 702 may wake as part of a periodic wake cycle, during which the application processor executes pending tasks or housekeeping functions. The computing device that includes the processors may remain in a sleep state, in which various components of the device also remain in respective low-power states. In some cases, the application processor 702 wakes a data transceiver of the device to enable communication of data with external entities.

At 708, the application processor 702 receives notifications. The notifications may be received from a server, a data network, another device, and the like. In some cases, a notification is received in response to querying the server or the data network for pending or queued notifications. The notifications may include any suitable type of content, such as text, a picture, video content, sound content, metadata, origination information, or contact information.

At 710, content of the notifications is rendered. In some cases, the content of a notification is partially rendered as a grayscale or low-resolution image. For example, a high-resolution image or video of a notification can be partially rendered as a grayscale image or as a single frame of video content. Alternately or additionally, text of the notification or other details of the notification are associated with the rendered content. In some cases, text of the notification, contact information of a sender, and/or a time of notification reception is associated with the rendered content of the notification.

At 712, the application processor 702 stores the rendered notification content. The rendered notification content is stored in a buffer that is accessible by the low-power processor 704 of the device. In some cases, the rendered notification content is stored in a discrete buffer, or part of a buffer, that is configured to store a component of image data. In such cases, the rendered content can be stored in any one of multiple color-channel buffers.

When previously rendered content occupies the multiple color-channel buffers, the application processor can replace the previously rendered content with more-recently rendered content. For example, a least-recently-used eviction process may be implemented to store rendered notification content to the multiple color-channel buffers. Alternately or additionally, the application processor can generate metadata linking the rendered content with a corresponding notification. This metadata is also stored to a memory of the device and associates the stored rendered content and the corresponding notification, which includes the content in an original or complete form.

At 714, the application processor 702 returns to the low-power state. The application processor 702 may remain in the low-power state until a next occurrence of a wake event, which may be periodic, application initiated, or user initiated. Prior to entering the low-power state, the application processor 702 may also cause other components of the device to return to a respective low-power state. In some cases, the application processor 702 notifies the low-power processor 704 of the transition to the low-power state.

At 716, the low-power processor 704 indicates availability of the notifications. The low-power processor 704 can indicate the availability of the notifications via a display or a light-emitting diode of the device. In some cases, symbols indicating various types of available respective notifications are presented via the display. Alternately or additionally, the display may be operably coupled with a touch-input sensor that enables interaction with these symbols.

At 718, a selection is received to preview one of the notifications. The selection can be received via any suitable input of the computing device, such as a touch screen, capacitive sensor, motion sensor, or hardware button. In some cases, the selection is received via a presented symbol that is associated with the notification. In other cases, the selection may be received as a voice command or a gesture of the device.

At 720, the low-power processor applies a mask to the rendered notification content to provide a preview of the notification. In some cases, the mask is applied based on the metadata linking rendered content of a notification with the corresponding notification. Applying the mask to the rendered notification content stored in the buffer is effective to prevent content associated with other non-selected notifications from being presented. In some cases, the mask is configured to mask data of particular color-channels such that rendered content stored in one color-channel is exposed to provide the preview of the notification content.

At 722, the preview of the notification content is presented via the display of the device. The preview of the notification content can be presented as a grayscale image, low-resolution image, or text. In some cases, the preview of the notification content enables further interaction with fully rendered content of the notification, such as high-resolution images, message conversations, multimedia content, video, and so on.

From operation 722, the method 700 may proceed to operation 724, or return to operation 716 or operation 706. For example, after the preview of the content notification is presented, the method 700 can indicate the availability of other notifications at 716 or wait for the application processor 702 to retrieve additional notifications by returning to operation 706.

At 724, input is received to view the selected notification. The input may be received via the preview of the notification content. For example, a touch-input may be received while a preview of the notification is presented via the display of the device. In such cases, the metadata associated with the previewed content of the notification can be used to determine which notification is selected.

At 726, the application processor 702 wakes to fully render the content of the notification. In some cases, the application processor 702 is awakened by an application that is invoked responsive to interaction with the preview of the notification content. In such cases, the application can access or fully-render the content of the notification using the application processor 702. The fully-rendered content of the notification is then presented via the display or speakers of the device to enable further interaction with the content.

FIG. 8 illustrates various components of an example electronic device 800 that can be implemented as a computing device as described with reference to any of the previous FIGS. 1-7. The device may be implemented as any one or combination of a fixed or mobile device, in any form of a consumer, computer, portable, user, communication, phone, navigation, gaming, messaging, Web browsing, paging, media playback, and/or other type of electronic device, such as the computing device 102 described with reference to FIG. 1.

The electronic device 800 includes communication transceivers 802 that enable wired and/or wireless communication of device data 804, such as transmitted data and received data (e.g., notifications). Example communication transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN, 3GPP-compliant) radios for cellular telephony, wireless metropolitan area network (WMAN) radios compliant with various IEEE 802.16 (WiMAX™) standards, and wired local area network (LAN) Ethernet transceivers.

The electronic device 800 may also include one or more data input ports 806 via which any type of data, media content, and/or inputs can be received, such as user-selectable inputs, messages, music, television content, recorded video content, and any other type of audio, video, and/or image data received from any content and/or data source. The data input ports 806 may include USB ports, coaxial cable ports, and other serial or parallel connectors (including internal connectors) for flash memory, DVDs, CDs, and the like. These data input ports may be used to couple the electronic device to components, peripherals, or accessories such as keyboards, microphones, or cameras.

The electronic device 800 of this example includes a processor system 808 (e.g., any of microprocessors, processor cores, and the like), or a processor and memory system (e.g., implemented as a SoC), which process computer-executable instructions to control operation of the device. The processor system may be implemented as an application processor or full-power processor, such as application processor 104 described with reference to FIG. 1. A processing system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware.

Alternatively or in addition, the electronic device can be implemented with any one or combination of software, hardware, firmware, or fixed logic circuitry that is implemented in connection with processing and control circuits, which are generally identified at 810. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

In embodiments, the electronic device 800 includes a low-power processor 812 (e.g., any of microprocessors, controllers, and the like), such as the low-power processor 106 described with reference to FIG. 1. The electronic device 800 may also include data switch 814, such as data switch 224 described with reference to FIG. 2. The low-power processor 812 and data switch 814 can be implemented to facilitate previewing notification content. For example, when the electronic device 800 enters a low-power state, the low-power processor 812 can be leveraged to expose rendered notification content, which is presented as a notification content preview by a display of the electronic device 800.

The electronic device 800 also includes one or more memory devices 816 that enable data storage, examples of which include random access memory (RAM), non-volatile memory (e.g., read-only memory (ROM), flash memory, EPROM, EEPROM, etc.), and a disk storage device. A memory device 816 provides data storage mechanisms to store the device data 804, other types of information and/or data, and various device applications 818 (e.g., software applications). For example, an operating system 820 can be maintained as software instructions with a memory device and executed by the processor system 808. In embodiments, the electronic device 800 includes a notification manager 822, such as the notification manager 114 described with reference to FIG. 1. Although represented as a software implementation, the notification manager may be implemented as any form of a control application, software application, signal-processing and control module, firmware that is installed on the device, a hardware implementation of the controller, and so on.

The electronic device 800 also includes an audio and/or video processing system 824 that processes audio data and/or passes through the audio and video data to an audio system 826 and/or to a display system 828. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 830. In implementations, the audio system and/or the display system are external components to the electronic device. Alternatively or in addition, the display system can be an integrated component of the example electronic device, such as part of an integrated touch interface. As described above the low-power processor 812, data switch 814, and notification manager 822 can be implemented to facilitate previewing notification content via the display system 828. For example, when the electronic device 800 enters a low-power state, the low-power processor 812 can be leveraged to expose low-resolution content for presentation by the display system 828 of the electronic device 800.

Although embodiments of previewing notification content have been described in language specific to features and/or methods, the subject of the appended claims is not necessarily limited to the specific features or methods described. Rather, the specific features and methods are disclosed as example implementations of previewing notification content.

1. A method comprising:
accessing, via a buffer of a device, a composite image of content associated with two or more notifications;
masking, via a processor of the device that is not in a state to render graphics, the composite image to expose the content associated with one of the two or more notifications; and
presenting, via a display of the device, the exposed content associated with the notification.

2. The method as recited in claim 1, wherein the buffer is a multi-channel buffer and the content of the composite image that corresponds with each of the two or more notifications is stored in a respective channel of the multi-channel buffer.

3. The method as recited in claim 2, wherein channels of the multi-channel buffer include color channels and the content associated with each of the two or more notifications includes grayscale content that is stored in a respective color channel of the multi-channel buffer.

4. The method as recited in claim 3, wherein the act of masking is configured to mask content stored in one or more of the color channels effective to expose content stored in another of the color channels.

5. The method as recited in claim 1, wherein the acts of accessing, masking, or presenting are performed while the device is in a low-power state in which an additional processor capable of rendering graphics is in a sleep state.

6. The method as recited in claim 5, wherein the exposed content associated with the notification is partially rendered content, and the method further comprises waking the additional processor capable of rendering graphics to provide content associated with the notification that is fully rendered.

7. The method as recited in claim 6, wherein the partially rendered content includes a grayscale image or text, and the fully rendered content includes at least one of a color image, video, sound, or music.

8. A method comprising:
indicating, while in a low-power mode, a presence of content associated with one or more notifications;
receiving a selection to view content associated with one of the notifications;
applying, via a processor not in a state to render graphics, a mask to the content effective to expose the content associated with the selected notification; and
present, via a display, the exposed content associated with the selected notification.

9. The method as recited in claim 8, wherein the content associated with each of the one or more notifications is stored in a respective color-channel buffer and the mask is configured to mask the content stored in one or more of the color-channels.

10. The method as recited in claim 9, wherein the color-channel buffers includes a red channel data buffer, a blue channel data buffer, and a green channel data buffer.

11. The method as recited in claim 9, wherein the content associated with each of the one or more notifications includes grayscale content that is stored in a respective one of the color-channel buffers.

12. The method as recited in claim 8 further comprising selecting, based on the selection to view the content associated with the notification, the mask to apply to the content from a plurality of masks, each of the plurality of masks configured to expose content associated with different ones of the notifications.

13. The method as recited in claim 8 further comprising, responsive to receiving an input via the exposed content that is presented via the display, exiting the low-power mode effective to enable interaction with the content associated with the notification.

14. A system comprising:
a display configured to present content;
a first processor capable of rendering graphics and configured to store, in a buffer, content associated with notifications;
a second processor that is not in a state to render graphics and configured to:
receive, from the buffer and while the first processor is in a sleep state, the content associated with the notifications;
apply a mask to the content received from the buffer effective to expose content associated with one of the notifications; and
present, via the display, the exposed content associated with the notification.

15. The system as recited in claim 14, wherein the second processor is further configured to:
indicate, while the first processor is in the sleep state, availability of the content associated with the notifications;
receive a selection to view the content associated with one of the notifications; and
apply, based on the selection, the mask to the content effective to expose the content associated with the selected notification.

16. The system as recited in claim 14, wherein the first processor is further configured to store the content associated with each of the notifications as a grayscale image.

17. The system as recited in claim 16, wherein the buffer is a graphical buffer that includes multiple color-channel buffers, and the first processor is further configured to write each grayscale image to a respective one of the color-channel buffers.

18. The system as recited in claim 17, wherein the mask is configured to mask data of one or more color-channels effective to expose one of the grayscale images stored in one of the color-channel buffers.

19. The system as recited in claim 14, wherein the content associated with the notifications includes at least one of an email, a short message service (SMS) message, a multimedia messaging service (MMS) message, a video message, missed-call information, a software update, a social-media message, or an application-specific alert.

20. The system as recited in claim 14, wherein the system is implemented as a smart phone, a tablet computer, a laptop computer, a gaming device, a set-top box, or a navigation device.
